(19) United States
(12) Patent Application Publication
(10) Pub. No.: US 2006/0219304 A1
(43) Pub. Date: Oct. 5, 2006

(54) Increased area single handle fluid cartridge

(76) Inventor: David Di Nunzio, Mentor, OH (US)

Correspondence Address: David Di Nunzio, 9314 Lake Shore, Mentor, OH, 44060, US

(21) Appl. No.: 11/389,338

(22) Filed: Mar. 25, 2006

Related U.S. Application Data
(60) Provisional application No. 60/667,289, filed on Apr. 1, 2005.

(51) Int. Cl. F16K 11/078

(52) U.S. Cl. 137/625.4

(57) ABSTRACT

A control disk insert for a one lever mixer valve (20) contains two preferably, planar disks, whereof one fixed control disk (24) has at least one opening zone for hot water and at least one opening zone for cold water. The movable control disk (22) facing the fixed control disk (24) and movable with two degrees of freedom can both completely close and continuously completely open the opening zones in the fixed control disk (24). The opening zones of the fixed control disk (24) and the closed control zones, i.e. openings (66,68) of the movable control disk are constructed in such a way that the control disk (22) insert has two completely separated, independently operating but mechanically coupled control systems. Both control systems can be used for a common water outlet (74), or for two separate water outlets. The fixed control disk (24) splits one or both inlet streams so that more intersecting flow area is possible at the control surface when compared to other current single handle mixing cartridges that do not let flow exit at the boundary of a movable disk control surface in communication with a fixed disk control surface.

### CROSS-REFERENCE TO RELATED APPLICATIONS

This application claims the benefit of provisional patent application Ser. No. 60/667,289 filed 2005 April 01 by the present inventor.

### FEDERALLY SPONSORED RESEARCH

Not Applicable

### SEQUENCE LISTING OR PROGRAM

Not Applicable

### BACKGROUND OF THE INVENTION

1. Field of the Invention

This invention relates to faucets which control the mixing of hot and cold water. More particularly, the invention relates to faucets of the foregoing type wherein a movable disk is both rotated and directed in a linear manner over a stationary disk by an operating spindle.

2. Prior Art

There are problems with certain mixing valves which utilize movable and stationary disks (e.g. ceramic disks). Prior art arrangements of faucets and mixing valves (e.g. cartridges) appear to suffer from common disadvantages such as (a) they restrict area of inlet water to a mixing chambers. (b) they require additional space for larger cartridges if more area is needed. (c) they require larger exterior components to house a larger cartridge if more area is needed. (d) they are more expensive to manufacture due to larger exterior components if more area is needed. (e) they are more expensive to manufacture due to larger cartridge if more area is needed. (f) they have a hot and a cold inlet hole that is positioned at the front of the cartridge which means that the cartridge outlet must be routed between the hot and cold inlet valve seat holes in order to get to a commonly positioned faucet spout. Also, cold and hot water inlet area at mounting surface of cartridge is often greater than inlet area of the control surface. Control surface refers to where a movable control disk and a fixed control disk form a seal plane for mixing.

Alternate cartridge designs that allow for increased area from hot and cold inlets do not maintain a seal beyond a perimeter of a movable disk. Such a problem can be particularly of concern when a control insert valve is employed like that described in U.S. Pat. No. 4,617,965 by Werner Lorch, when a fluid stream is not contained within the perimeter of a movable disk. More specifically, the U.S. Pat. No. 4,617,965 refers to a cartridge e.g. control insert with a condition where all inlet fluid streams do not pass through openings in the movable control surface. Since the fluid crosses a control surface boundary rather than pass through a movable control surface, fluid beyond the perimeter of a movable disk requires a sealed cartridge housing and additional seals to contain fluid inside such a cartridge. Also, use of such a cartridge for only one outlet use can result in stagnant water inside of the cartridge. Further, to use a cartridge with increased inlet area can require 4 inlet ports on the bottom of such a cartridge. Cartridge designs that allow for increased area have 2 inlet ports connecting to hot water and 2 inlet ports connecting to cold water at cartridge mounting surface.

Other cartridge designs claim optimal volume by enlarging the area of inlets in U.S. Pat. No. 5,857,489 by Chia-Bo Chang. Optimal volume cartridge described in U.S. Pat. No. 5,857,489 is declared to be a step toward increased area for cartridges that employ a simple central mix chamber in or directly above control disks. Simple mixing chambers are bound by the underside of a movable control disk or simple mixing chambers are bound by the mixing plane in combination with the central area of a movable control disk in addition to a seal interfacing a drive part that provides an upper boundary. Smaller cartridges that have simple mixing chambers are numerous and common in most faucets yet they all seem to share inlet area limitations at the seal plane.

There are temperature controlled mixer valves like the one in U.S. Pat. No. 6,676,025 by Gerhard Ginter, where a fluid cartridge employs a temperature regulating unit. Such cartridges are not well suited for applications where a smaller cartridge is desirable.

There are also cartridges that have an outlet channel that can route the outlet to the front of a cartridge in the valve cartridge base. Such a cartridge is in existence and currently being sold by Kuching International LTD. Of Taiwan. Though the cartridge is a clever design, limitations present themselves when such a cartridge is desired in smaller sizes where space is tight. Such cartridges are available in sizes 35 mm and 40 mm. These cartridges are approximately 3 mm taller in order to accommodate the additional flow channel. Further, these cartridge require a larger surface area for mounting and therefore a larger surface area must have adequate finish in order to seal properly. Added cost and complexity in manufacturing and accommodating such disks can be unwanted.

### BACKGROUND OF INVENTION—OBJECTS AND ADVANTAGES

Accordingly, several objects and advantages of the present invention are:

(a) to provide a cartridge with a larger area for hot and cold water to enter a mixing chamber;

(b) to provide a cartridge with outer walls or peripheral components that do not contain fluid.

(c) to provide a smaller cartridge in new applications that require larger existing cartridges based on desired flow area

(d) to provide smaller components of cartridges

(e) to provide smaller components housing cartridges

(f) to provide designers more freedom to make more appealing designs based on smaller possible shapes

(g) to provide a cartridge with increased area for hot and cold inlet at control surface without necessarily requiring 2 input ports for hot water and 2 input ports for cold water at cartridge base

(h) to provide a replacement cartridge for existing faucets that currently have inadequate flow area

(i) To provide a cartridge that can have an outlet port that is positioned at the front of the valve

(j) To provide numerous cartridge sizes that can have an outlet port that is positioned at the front of the valve

Further objects and advantages are to provide a compact cartridge that may be suitable for applications that require more area than similar sized cartridges that are currently available. Still further objects and advantages will become apparent from a consideration of the ensuing description and drawings.

### SUMMARY

The invention provides increased inlet area at a control surface to facilitate the efficient mixing of hot and cold water. The inlet area at the control surface of this cartridge compares to much larger cartridges. The invention can be utilized in current applications that have inadequate inlet area at a given size requirement. Shower and bath applications where larger flow areas are common may also benefit from such an invention. Also, cartridges that have an outlet at the front can be combined with very simple valve plates and further simplified faucet arrangements. Finally, cartridges that can have the inlets positioned at various locations with respect to the cartridge bottom have additional functionality that is not available in similar 3 port cartridges.

### DRAWINGS—FIGURES

The invention is described in greater detail hereinafter relative to non-limitative embodiments and the attached drawings, wherein:

FIG. 1 is a cross-section through part of a mixer valve with a control insert according to the invention.

FIG. 2 is a cross-section from a direction turned 90° relative to FIG. 1 with the control rod rotated respectively.

FIG. 3 is a top view of the moveable control disk of the arrangement according to FIG. 1

FIG. 4 is a bottom view of the moveable control disk of the arrangement according to FIG. 1

FIG. 5 is a cross-section through the arrangement according to FIG. 4

FIG. 6 is a cross-section through the arrangement according to FIG. 4

FIG. 7 is a top view of the fixed control disk of the arrangement according to FIG. 1

FIG. 8 is a bottom view of the fixed control disk of the arrangement according to FIG. 1

FIG. 9 is a cross-section through the arrangement according to FIG. 7

FIG. 10 is a cross-section through the arrangement according to FIG. 7

FIG. 11 is a bottom view of the lower fixed control disk of the arrangement according to FIG. 1

FIG. 12 is a top view of the lower fixed control disk of the arrangement according to FIG. 1

FIG. 13 is a cross-section through the arrangement according to FIG. 12

FIG. 14 is a cross-section through the arrangement according to FIG. 12

FIG. 15 is a cross-section through the arrangement according to FIG. 12

FIGS. 16 to 20 are diagrammatically positions of fixed and movable control disks.

FIG. 21 is an exploded view of the valve of FIG. 1.

### DRAWINGS—REFERENCE NUMERALS

20 cartridge
21 cartridge housing
22 movable control disk
23 bearing surface
24 fixed control disk
25 flange
26 valve seat
27 bearing surface
28 cavity
29 Fixed disk
30 rotative control rod device
32 cover seat
34 attachment
36 cavity
38 motion transmission element
40 o-ring
42 protrusion feature
44 inlet cavity
46 inlet cavity
48 eccentric shaped cavity
50 mixing chamber
51 surface
52 hot water inlet
53 seal
54 hot water inlet
56 cold water inlet
58 cold water inlet
59 upper limit surface
60 seal slot
62 seal
64 opening
66 opening
68 opening
69 outlet
70 protrusion
74 outlet
79 channel
80 channel
81 protrusion
144 outlet
145 inlet
146 outlet
147 inlet
148 inlet
149 inlet
174 inlet

### DETAILED DESCRIPTION—PREFERRED EMBODIMENT

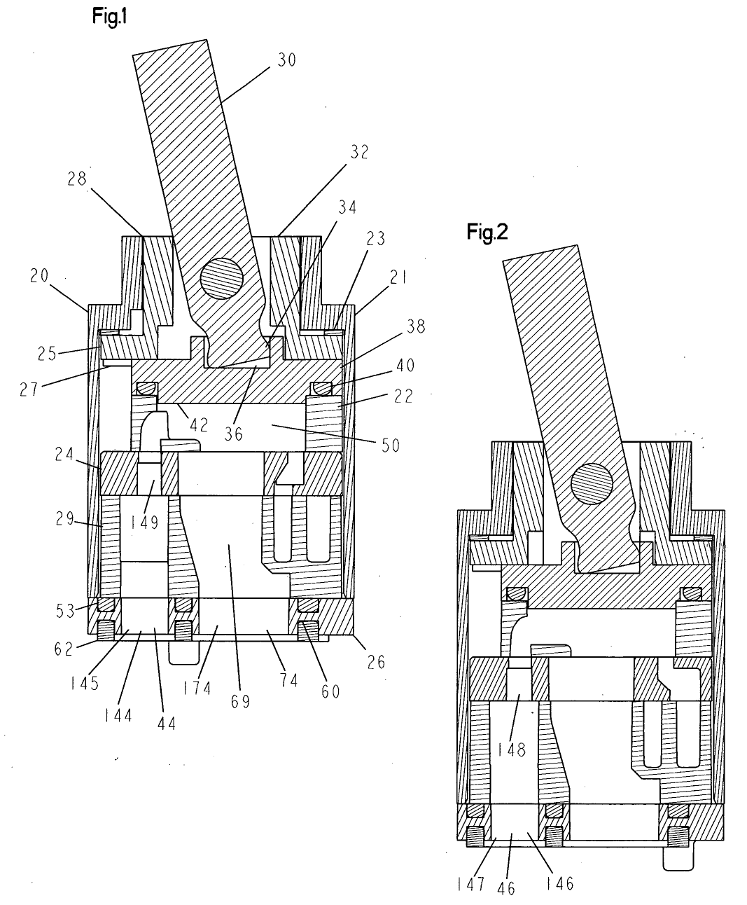

Referring to the attached drawings FIG. 1 and FIG. 2, the present invention generally includes a cartridge 20, a movable control disk 22, a fixed control disk 24, a bottom fixed disk 29 and a valve seat 26. A bearing surface 23 is located above a flange 25. A cartridge housing 21 is cylindrical, on the top, there is a cavity 28 of a smaller diameter. A rotative control rod device 30 is inserted in the cavity 28. The control rod 30 swings through the central axis of a cover seat 32, and includes an attachment 34. The control rod 30 extends down and continuous in an attachment 34 from a cover seat 32. The attachment 34 is placed in a corresponding cavity 36. The cavity 36 is located in an upper portion of a motion transmission element 38. A bearing surface 27 is located above transmission element 38. The transmission element 38 provides a range of motion for the control rod 30. An, O-ring 40 is beneath the transmission element 38 where said O-ring 40 seals transmission element 38 with the movable control disk 22. The transmission element 38 is equipped with a protrusion feature 42 extending downward into control disk 22. There are also two inlet cavities 44 and 46.

Referring to the FIGS. 1,3,4 and 5, the moveable disk 22 is a smaller diameter than the aforesaid cartridge 20. There is an eccentric shaped cavity 48 in the upper surface of the movable disk 22. The cavity 48 corresponds with a similar shaped protrusion feature 42 on the underside of the transmission element 38. The transmission element 38 is able to be inserted into the moveable disk 22 and to be mounted in the cartridge 20 while moving freely relative to the fixed control disk 24. Also, there is a mixing chamber 50 in the movable control disk 22. The mixing chamber 50 is connected to openings 66 and 68 in the movable control disk.

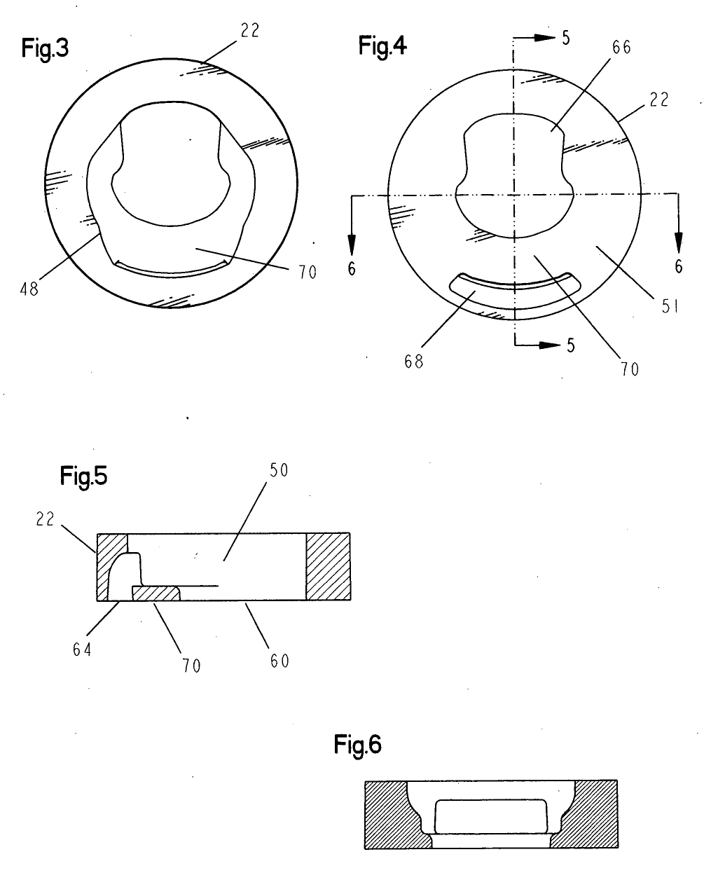

A valve seat 26 inserts and engages at bottom of the cartridge 20 and positions a seal 53, a bottom fixed disk 29 and the fixed control disk 24 in the cartridge. The moveable disk 22 is subjected to the movement of the control rod 30 and is able to move and overlap the fixed control disk 24. The control rod 30 drives the moveable disk 22 and alters various positions of the moveable disk 22 in relation to the fixed disk 24 (see FIGS. 16 to 20). The movable control disk 22 (FIG. 3 to 6) has a lower limit surface which forms the movable control surface 51. To provide for outlet 74 water flow (FIG. 1), the movable control disk (FIGS. 16 to 20) openings 66 and 68 connect to both diametrically opposed hot water inlets 52 and 54 or both diametrically opposed cold water inlets 56 and 58 or a combination of all diametrically opposed cold water and hot water inlets. All water exits the movable control disk by passing through outlet 69 of the fixed control disk 24. By way of the aforementioned connections, the movable control disk 22 is able to open or close or mix or deliver hot and cold water. Openings 66 and 68 connect to the mixing chamber 50. The mixing chamber 50 is able to open or close or mix or deliver hot and cold water to outlet 69.

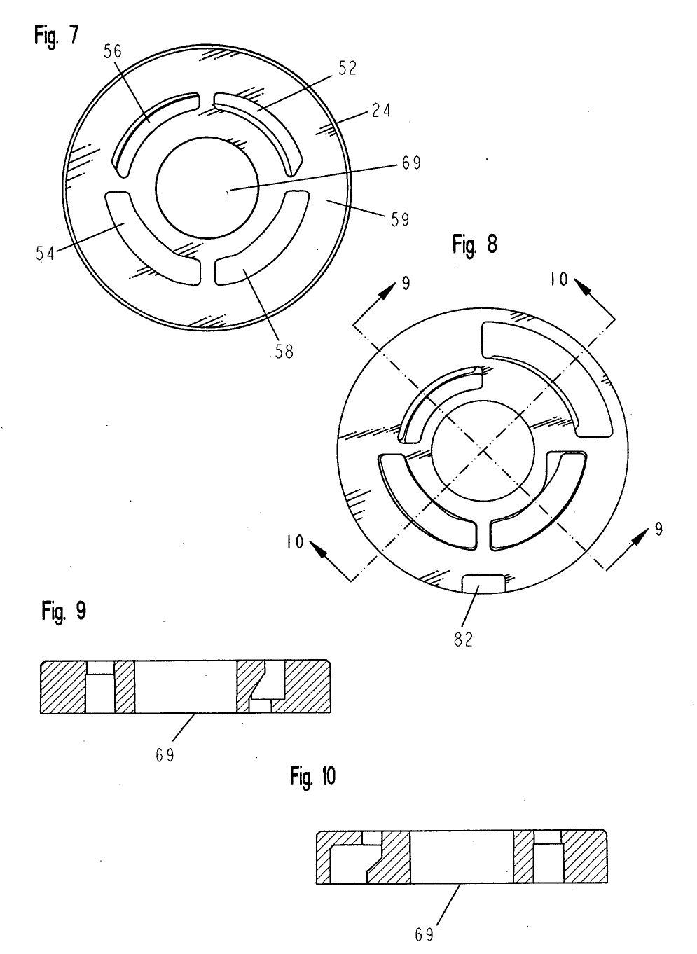

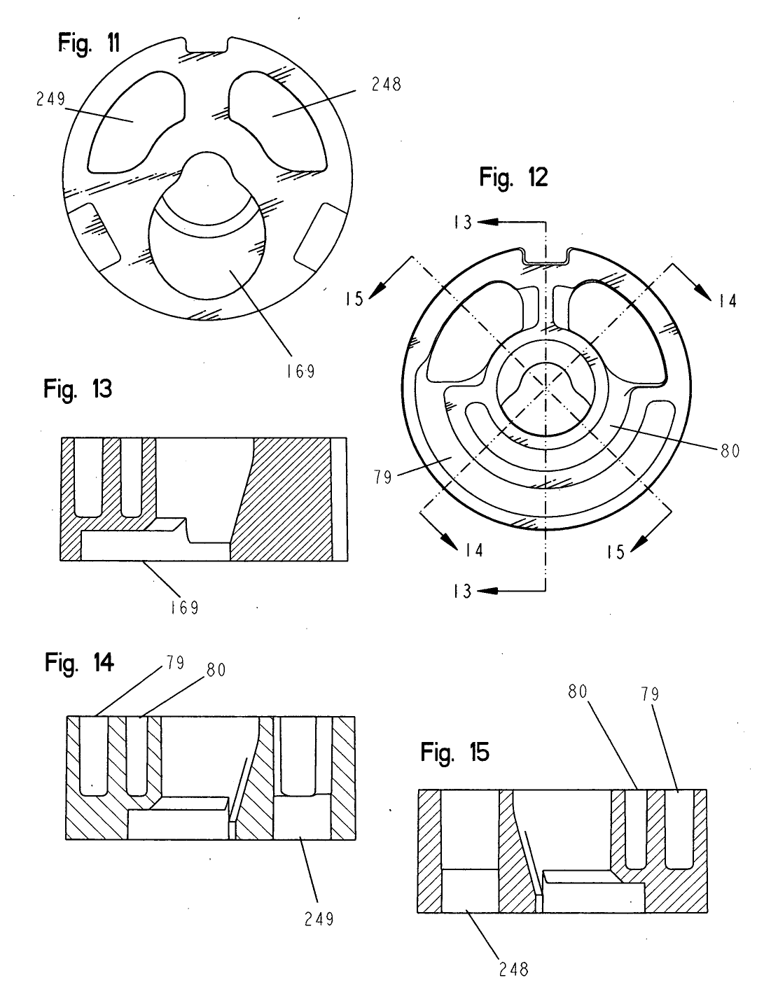

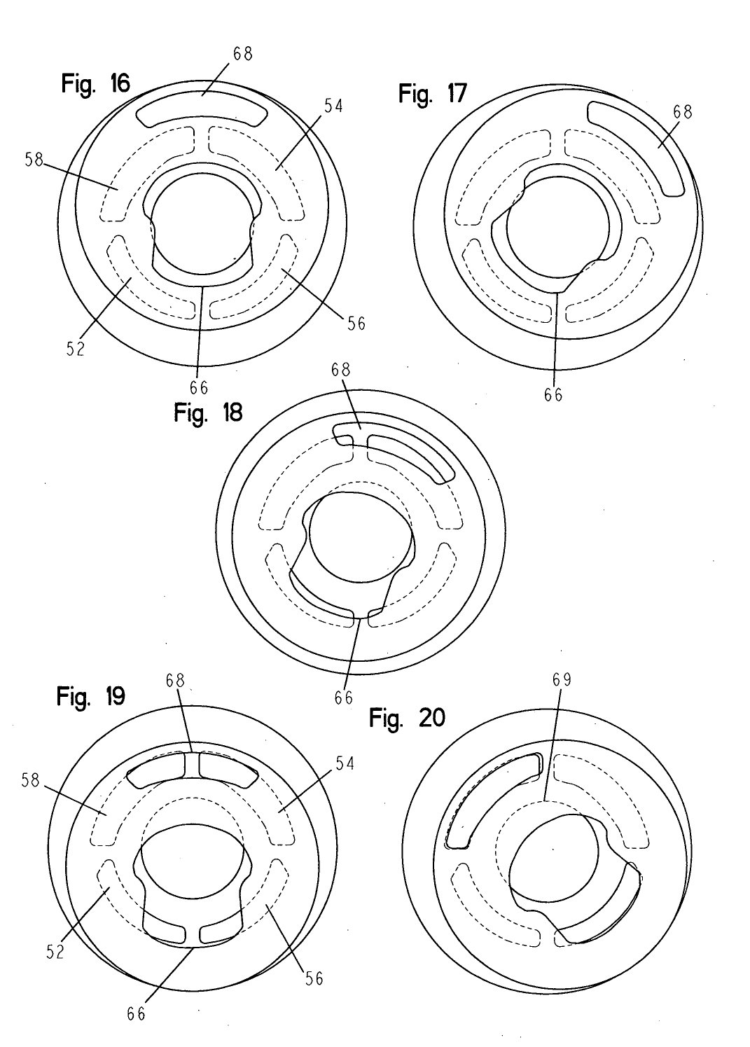

See FIGS. 1,2,7,8 and 21. Below the movable control disk 22, the fixed control disk 24 is secured in the cartridge by void 82 in the fixed control disk 24 and by protrusion 81 in valve seat 26. The fixed control disk 24 has an upper limit surface 59 which forms the fixed control surface. The fixed control disk 24 has inlets 148,149 that receive flow from inlet cavities 46 and 44 respectively. The only diagrammatically represented fixed control disk 24 rest partly on the seal 53 and valve seat 26. Below the fixed control disk 24, there is a fixed disk 29 that does not have a control surface. In FIGS. 11 to 15, the fixed disk 29 contains channels 79 and 80 which have varying geometric cross sections suitable to accommodate desired flow area. In FIGS. 11 and 15, the channels 79 and 80 route the water flow to the fixed control disk 24 inlets 52 and 56 in FIG. 7. Channels 79 and 80 receive water flow originating from inlet cavities 46 and 44 of FIGS. 1 and 2.

The valve seat 26 has A protrusion 81 which can secure the fixed control disk 24 and the fixed disk 29. Also, protrusion 81 can limit and balance compression of the fixed disk 24 with respect to seal 53 if assembled with a number of protrusions similar to protrusion 81 with accompanying notches as well. Seal 53 seals flow paths between the fixed disk 29 and the valve seat 26.

In FIG. 1, you can see a seal slot 60 in the valve seat 26. A seal 62 covers seal slot 60 in order to prevent leakage between the valve seat and all inlets and outlets.

It is common practice to use a flat surface of two disks to form a seal plane by placing what we call control surfaces against each other to form a seal plain where one of the control surfaces can move with respect to another control surface.

In order to be clear, the term opening zone in a control surface means an opening in a control surface where an edge of said opening zone does not share an edge with a perimeter or boundary of said control surface.

With reference to FIGS. 4,7 and FIGS. 16 to 20, the interactions of the two control disks for mixing the two water flows and for setting the water quantity will now be described. A rotation of the movable control disk 22 leads to a temperature change, whilst a displacement of the movable control disk in a direction of an alignment passing through the center of the 2 openings 66 and 68 permits the choice of the water quantity. In FIG. 20 the moveable control disk 22 is rotated counter clockwise to its end position and is simultaneously displaced to the right and downwards. The opening 68 of the moveable control disk 22 frees opening 58 of the fixed control disk 24, which is to be connected with the cold water. Simultaneously, the opening 66 of the moveable control disk 22 frees opening 56, which is also connected to the cold water inlet. This position consequently means maximum opening at cold temperature.

If the moveable control disk 22 is now rotated clockwise, then the situation is as shown in FIG. 19. Opening 68 frees to an equal extent the openings 58,52 in the fixed control disk, whereas the opening 66 also to a roughly identical extent frees the openings 52 and 56. Thus, FIG. 19 shows the control insert position with a 50% mixing ratio.

FIG. 18 shows the moveable control disk 22 rotated to some extent clockwise with respect to the position in FIG. 19 and is simultaneously displaced somewhat to the right and upwards so that a somewhat hotter temperature with a somewhat lower flow rate is set.

If the moveable control disk 22 is moved upwards from the position in FIG. 19 without turning it, the position shown in FIG. 16 is obtained, in which the valve is closed in the central temperature position. In this closed position, control disk 22 can be rotated both clockwise and counterclockwise without the valve opening. In FIG. 17, the off position of the full hot orientation is displayed.

### ALTERNATIVE EMBODIMENTS

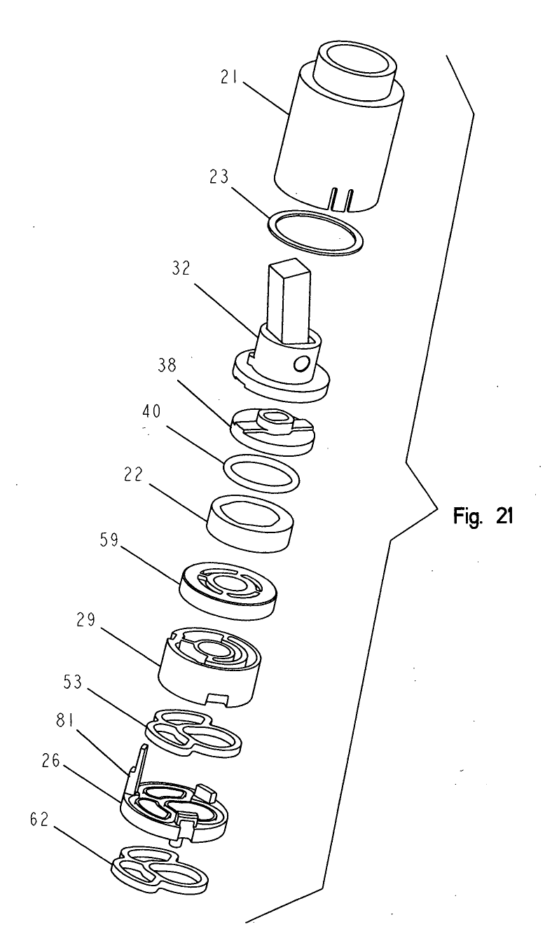

With reference to FIGS. 1 to 6 and 21, there can be instances where a facility might want to maintain the temperature of the hot water a bit hotter than some people might feel is comfortable. Such facilities could use this invention where one of the dual hot water inlets 54 or 52 is not present in the fixed control disk 24. Therefore, the proportion of hot water to cold water could be changed and some people might find such conditions favorable. Similarly, this invention can also function as a cartridge that reduces the use of hot water. As noted in U.S. Pat. No. 6,845,917 by Mei-Li Chen a cartridge can be designed so as to reduce the use of hot water by changing the amount of inlet area overlapping with the control surfaces.

Also, there are certain applications where a facility might not keep the hot water at a high enough temperature for a majority of the patrons that use their rest rooms. These patrons could run the water excessively before the temperature is hot enough for their comfort. Such facilities could use this invention without one of the dual cold water outlets 56 or 58 in the fixed control disk 24 thereby reducing the waste of water and improving the response time in a mid position orientation of the cartridge handle.

The newly invented cartridge can also reduce inventory requirements by using the same fixed disk 24 in all assembled cartridges. In applications where higher flow is not desired, the movable control disk 22 can simply be fabricated without one of the two openings 64 or 68. Thus, a current typical cartridge performance may be achieved. Also, that typical cartridge performance can be coupled with an outlet port that is at the front of the valve. Or, the cartridge could be constructed where opening 66 only operates as an outlet. In the absence of diametrically opposed inlets in the fixed control disk, opening 68 could be the only inlet point for the mixing chamber and therefore a cartridge that functions with only one hot and one cold opening in a fixed disk could function with similar flow to existing cartridges with the added benefit of having an outlet positioned at the front of the cartridge.

There are some applications where the invention can be used to mix and have two separate mixing outlets. It is very simple to divide the outlet chamber into two separate outlets. And, it would be easy to have two different mixing paths with different mixing rations due to different areas on the diametrically opposed inlet holes of the fixed control disk. Tub and bath applications could be an excellent use for the inventions.

The newly invented cartridge could easily have the translation or volume controlling throw positions divided into two index-able positions to allow for choosing typical cartridge flow or the newly improved cartridge flow.

Also, the geometric features of the movable control disk 22 and fixed control disks 24 lend themselves to being fabricated out of ceramic, alumina etc. or even polymeric materials that may provide reasonable cost, life and performance. Furthermore, The movable and fixed control disks can be molded or formed by simple male and female molds without the need for slides or inserts.

The following lists some specific conditions for the valve cartridge referencing FIGS. 1 and 2. A cartridge 20 can be seated on a surface that allows for only one fluid inlet at 174 and then function with two fluid outlets 144,146.

Also the cartridge 20 can be seated on a surface that allows for two fluid inlets at 145,174 and one fluid outlet 146.

In addition, the cartridge 20 can be seated on a surface that allows for two fluid inlets at 147,174 and one fluid outlet 144.

Further, the cartridge 20 can be seated on a surface that allows for one fluid inlet at inlet cavity 44 and one fluid outlet 146.

Another alternate cartridge can have four separate fluid inlets and one or two outlets to function like similar 4 in port cartridges that have more components, are more complex, costly and therefore less desirable. However, this 4 in port would be a more simple 4 in port cartridge than those that are currently available.

The newly invented cartridge can be used with inlet 174 and modified fixed control disk opening zone shapes. Such a cartridge could operate as a proportioning valve where the shapes of the opening zones are similar to the current shapes or they could be arranged with shapes that do not allow for the complete closing of the cartridge. In other words, at least one of the opening zones might always overlap opening 66 at any given position. In this way, a proportioning of outlets 144 and 147 could be achieved. Similarly, a proportioning of a 4 output cartridge could be achieved in a similar manner.

Also, the cartridge can be constructed using similar protrusion notches or pawls to secure the moveable control disk to the motion transmission element as is done in current cartridge designs.

Furthermore, the cartridge can be constructed using similar protrusion notches or pawls to secure and balance the fixed control disk to the valve seat as is done in current cartridge designs.

Additionally, the cartridge can be constructed using similar snap locking features that are currently used to secure the cartridge outer shell to the valve seat.

Similarly, the cartridge can be constructed similar to existing cartridges without requiring additional parts. From an appearance standpoint, the main differences distinguishing this invention from other cartridges are related to the geometry of the control disks, fixed disk and sealing.

When the invention is compared to equal size compact cartridges, the cost and complexity of cartridges are similar.

When the invention is compared to cartridges with equal overlapping control surface inlet areas, the cost of the newly invented cartridge and surrounding components can be substantially less.

The moveable control disk of this invention can be used to control the flow in other cartridge assemblies that do not have diametrically opposed inlets. Implementing such a design could reduce inventory of alternate parts for differing cartridges.

Also, the shapes of opening 66 and 68 in moveable control disk 22 can be modified so that equal or unequal areas can be accommodated for reasons which effect flow rates, timing or flow proportions through the channels 78 and 80 of fixed disk 29.

Also, the elimination of channels where only one inlet for each respective stream is necessary would be a simple variation.

Further, the shapes of inlets 52,54,56 and 58 in fixed control disk 24 can be modified for reasons that effect various flow rates or flow proportions through the channels 78 and 80 of fixed control disk 24. In some instances, the elimination of channels 78 and 80 would be appropriate. Also, an embodiment could require the elimination of one of the diametrically opposed fixed control disk 24 inlets for each case hot and cold. Desired conditions can dictate the aforementioned geometry descriptions. For instance, sound, flow, quality or operation feedback needs may be manipulated by such changes in addition to the frontal position of an outlet with respect to a typically positioned spicket.

Although the description above contains many specificities, these should not be construed as limiting the scope of the invention but as merely providing illustrations of some of the presently preferred embodiments of this invention.

Thus the scope of the invention should be determined by the appended claims and their legal equivalents, rather than by examples given.

Advantages

The numerous advantages in the aforementioned items generally relate to flow area, size, cost and versatility. The newly invented cartridge can be used in many different applications where the smaller diameter is desired or where the in port locations can have preferred location. Also, the cartridge may be used in applications where a cheaper alternative cartridge is desired. There may be numerous applications for which this cartridge may be preferred over the prior art.

I claim:

1. A sanitary mixer valve with a fixed control disk connectable to water inlet ports of said valve, said fixed control disk having at least one inlet for cold water and at least one inlet for hot water, a movable control surface having at least two opening zones mechanically coupled and movable with respect to a fixed control surface with two degrees of freedom, a mixer lever attached to the movable control surface for controlling quantity and mixing ration between opening zones as a function of position, wherein:
a movable control surface having one opening zone that can overlap at least one fixed control surface inlet while a second opening zone in the moveable control surface can simultaneously overlap at least one outlet in a fixed control surface as a function of position where said opening zones are in communication with each other.

2. A valve according to claim 1, wherein said opening zones are not separated by seals.

3. A valve according to claim 1, wherein a movable control surface having an opening zone that can simultaneously overlap at least one inlet and at least one outlet in a fixed control surface as a function of position where said opening zone is in communication with a mixing chamber, said moveable control surface has a second opening zone connecting at least one separate fixed control surface inlet to said mixing chamber.

4. A valve according to claim 1, wherein two mixing flow paths lead to a common water outlet.

5. A valve according to claim 1, wherein said movable control surface has one opening zone movable across said fixed control surface inlet ports for controllably mixing water along one mixing flow path and a second opening zone mechanically coupled to said first opening zone and movable across said inlet ports for controlling a second mixing flow path.

6. A valve according to claim 1, wherein an opening zone in the moveable control surface is in communication with a separate opening zone in the moveable control surface, where communication at least partly occurs between the moveable control surface and a plane or sealed zone defined by a mechanically sealed opposing side of a movable control disk.

7. A valve according to claim 1, wherein the fixed control surface has in each case two opening zones functioning as inlets for each opening zone in the movable control surface functioning at least partly as an inlet.

8. A valve according to claim 1, wherein a moveable control surface has an opening zone that is in communication with a separate opening zone in the moveable control surface, where communication at least partly occurs between the moveable control surface and a plane or sealing zone defined by a mechanically sealed opposing side of the movable control disk.

9. A valve according to claim 1, wherein two opening zones for each of the mixing flow paths diametrically face one another.

10. A valve according to claim 1, wherein the fixed control surface also has openings defining a path to a water outlet.

11. A valve according to claim 1, wherein a fixed control disk functions in order to divide the flow of an inlet streams of said valve.

12. A sanitary mixer valve with a fixed control disk connectable to water inlet ports of the valve, the fixed control disk having at least one inlet for cold water and at least one inlet for hot water, a movable control surface having at least two opening zones mechanically coupled and movable with respect to a fixed control surface with two degrees of freedom, a mixer lever attached to the movable control surface for controlling quantity and mixing ration between opening zones as a function of position, wherein:
a movable control surface having an opening zone that can simultaneously overlap at least one inlet and at least one outlet in a fixed control surface as a function of position where said opening zone is in communication with a mixing chamber, said moveable control surface has a second opening zone connecting at least one separate fixed control surface inlet to an outlet in the fixed control surface
a movable control disk having a control surface on one side and having at least two through holes emanating from at least 2 opening zones in said moveable control surface, at least one through hole functions at least in part as an inlet and at least one through hole functions at least in part as an outlet, both said through holes are contained by a mechanically sealed opposing side of the movable control disk.

13. A control insert for a sanitary mixer valve having means for connection to hot water and cold water supplies and having at least one outlet, the control insert comprising:
a fixed control surface which can be connected to water inlet ports of said valve, said fixed control surface having openings defining at least one opening zone for cold water and at least one opening zone for hot water from the supplies
a movable control surface having at least two opening zones cooperating with the fixed control surface with two degrees of freedom, and a mixer lever connected to the movable control surface for controlling quantity and mixing ratio as function of relative position of the fixed and movable control surface, movement of the control surfaces controlling alignment of openings in the movable control surface with at least one of the opening zones and the at least one water outlet, wherein at least two separable mechanically coupled flow paths are defined, the flow paths each having controllable connection to the hot water and cold water supplies.

14. A control insert according to claim 13, wherein the two mixing flow paths lead to a common water outlet.

15. A control insert according to claim 13, wherein the fixed control surface has in each case two opening zones for each opening zone in the movable control surface.

16. A control insert according to claim 13, wherein two opening zones for each of the mixing flow paths diametrically face one another.

17. A control insert according to claim 13, wherein the fixed control surface also has openings defining a path to a water outlet.

18. A valve according to claim 13, wherein a fixed control disk functions in order to divide the flow of an inlet streams of said valve.

19. A control insert according to claim 13, wherein a moveable control surface has an opening zone that is in communication with a separate opening zone in the moveable control surface, where communication at least partly occurs between the moveable control surface and a plane or a seal zone defined by a mechanically sealed opposing side of a movable control disk.

20. A control insert according to claim 13, wherein both mixing flow paths have at least partly corresponding control characteristics.

21. A control insert according to claim 13, wherein facing opening zones extend over roughly equal angles.

22. A control insert according to claim 13, wherein facing opening zones have cross sections of different areas.

23. A control insert according to claim 13, wherein a movable control surface having an opening zone that can simultaneously overlap at least one inlet and at least one outlet in a fixed control surface as a function of position where said opening zone is in communication with a mixing chamber, said moveable control surface has a second opening zone connecting at least one separate fixed control surface inlet to said mixing chamber.

24. A control insert according to claim 13, wherein the mixing flow paths have different flow characteristics.

25. A sanitary mixer valve with a fixed control surface connectable to water inlet ports of the valve, the fixed control surface having at least one opening zone for cold water and at least one opening zone for hot water, a control surface movable with respect to said fixed control surface with two degrees of freedom, a mixer lever attached to the movable control surface for controlling quantity and mixing ration between the opening zones and at least one out port as a function of position, wherein:
the fixed and movable control surfaces define at least two mechanically coupled controlled mixing flow paths and said movable control surface has at least 2 opening zones.

26. A mixer valve according to claim 25, wherein one of the said 2 opening zones overlaps at least one inlet and part of the mixing outlet zone at control surface of fixed disk as a function of position.

27. A mixer valve according to claim 25, capable of mixing two separate cold water streams that enter cartridge from one entry location at underside of valve seat.

28. A mixer valve according to claim 25, capable of mixing two separate hot water streams that enter cartridge from one entry location at underside of valve seat.

29. A mixer valve according to claim 25, wherein all fluid passing in through the control surface must pass back out through the control surface.

30. A sanitary mixer valve with a fixed control surface connectable to water inlet ports of said valve, said fixed control surface having at least one opening zone for cold water and at least one opening zone for hot water, a control surface movable with respect to said fixed control surface with two degrees of freedom, a mixer lever attached to said movable control surface for controlling quantity and mixing ration between said opening zones and at least one out port as a function of position, wherein:
said valve is capable of mixing two separate cold water streams that enter valve from one entry location at underside of valve seat
said valve is capable of mixing two separate hot water streams that enter valve from one entry location at underside of valve seat.

31. sanitary mixer valve with a fixed control surface connectable to water inlet ports of the valve, the fixed control surface having at least one opening zone for cold water and at least one opening zone for hot water, a control surface movable with respect to said fixed control surface with two degrees of freedom, a mixer lever attached to the movable control surface for controlling quantity and mixing ration between the opening zones and at least one out port as a function of position, wherein:
the valve is capable of feeding one cold water stream that enters valve from one entry location at underside of valve seat
the valve is capable of mixing two separate hot water streams that enter valve from one entry location at underside of valve seat.

32. sanitary mixer valve with a fixed control surface connectable to water inlet ports of the valve, the fixed control surface having at least one opening zone for cold water and at least one opening zone for hot water, a control surface movable with respect to said fixed control surface with two degrees of freedom, a mixer lever attached to the movable control surface for controlling quantity and mixing ration between the opening zones and at least one out port as a function of position, wherein:
the valve is capable of feeding one hot water stream that enters valve from one entry location at underside of valve seat
the valve is capable of mixing two separate cold water streams that enter valve from one entry location at underside of valve seat.

33. a valve with a fixed control disk connectable to a water inlet port of said valve, a front of said valve being designated as where an upper portion of a pivotally positional adjustment rod is generally or centrally positioned toward when said valve is in a closed position, a back of said valve being designated as the opposing diametrical side of said front, a fixed control disk having at least one inlet and at least one outlet, a movable control surface having at least two opening zones where one of said opening zones functions as an inlet at a back portion of a movable disk,

34. A valve according to claim 33, wherein inlets are located at a mid or back portion of a valve seat

35. A valve according to claim 33, wherein a fixed disk outlet hole is closer to the front of said valve than the valve seat inlets are with respect to said front of valve
